(19) United States
(12) Patent Application Publication
(10) Pub. No.: US 2024/0399596 A1
(43) Pub. Date: Dec. 5, 2024

(54) ROBOT HAND

(71) Applicant: Panasonic Automotive Systems Co., Ltd., Kanagawa (JP)

(72) Inventors: Masahiro KATO, Kanagawa Ken (JP); Ikuya WAKAMORI, Kanagawa Ken (JP); Kazushi HIRAMURA, Kanagawa Ken (JP)

(73) Assignee: Panasonic Automotive Systems Co., Ltd., Kanagawa (JP)

(21) Appl. No.: 18/656,103

(22) Filed: May 6, 2024

(30) Foreign Application Priority Data
May 29, 2023 (JP) 2023-087575

(51) Int. Cl. B25J 15/06

(52) U.S. Cl. CPC B25J 15/0616

(57) ABSTRACT

A robot hand includes: a hand unit that grips a target object including a first member in a first direction and a second member in a second direction; and a control unit that controls the hand unit. The hand unit includes: a body portion including a suction pad that sucks the second member to grip the target object and a support portion that supports the suction pad; and an auxiliary portion provided to be opposed to the body portion when the suction pad grips the target object. When the suction pad grips the target object, a distance in the second direction between an axis of the suction pad and the auxiliary portion is larger than a distance in the second direction from the axis to a surface of the first member on a side opposite to a surface of the first member brought into contact with the second member.

### CROSS-REFERENCE TO RELATED APPLICATIONS

This application is based upon and claims the benefit of priority from Japanese Patent Application No. 2023-087575, filed on May 29, 2023, the entire contents of which are incorporated herein by reference.

### FIELD

Embodiments described herein relate generally to a robot hand.

### BACKGROUND

Some robots grip a target object and move the target object (see, for example, JP 2020-163479 A).

However, the conventional robots do not consider the change in the posture of the target object; therefore, when assembling another component to the target object to manufacture a structure, the posture of the target object needs to be changed again, which poses a problem that the structure assembly work takes time and effort.

### SUMMARY

A robot hand according to an embodiment of the present disclosure includes: a hand unit configured to grip a target object including a first member extending in a first direction and a second member extending in a second direction intersecting the first direction; and a control unit configured to control the hand unit. The hand unit includes: a body portion including a suction pad configured to suck the second member to grip the target object and a support portion configured to support the suction pad; and an auxiliary portion provided to be opposed to the body portion in a state where the suction pad grips the target object. In a state where the suction pad grips the target object, a distance in the second direction between an axis of the suction pad and the auxiliary portion is larger than a distance in the second direction from the axis of the suction pad to a surface of the first member on a side opposite to a surface of the first member brought into contact with the second member.

### BRIEF DESCRIPTION OF THE DRAWINGS

FIG. 1 is a schematic configuration view of a robot including a robot hand according to a first embodiment;

FIG. 2 is a perspective view illustrating a target object to be gripped by the robot hand;

FIG. 3 is an enlarged view of the robot hand in the robot illustrated in FIG. 1;

FIG. 4 is a view illustrating a state in which an imaging unit included in the robot recognizes a position of the target object;

FIG. 5 is a view illustrating a state in which the robot hand is moved above the target object;

FIG. 6 is a schematic view illustrating a state in which a distal end of a suction pad is brought into contact with a second member of the target object;

FIG. 7 is a schematic view illustrating a state in which the robot hand grips the target object in a standing posture;

FIG. 8 is a schematic view illustrating a state in which the robot hand grips the target object in a lying posture;

FIG. 9 is a partially enlarged view illustrating the state in which the robot hand grips the target object in the lying posture;

FIG. 10(A) is a schematic plan view illustrating the suction pad and a support portion used in a verification model for verifying a relationship between an intersection angle and an allowable moment, FIG. 10(B) is a schematic front view of the suction pad and an auxiliary portion used in the verification model, and FIG. 10(C) is a view illustrating a state in which a part of the target object is brought into contact with the auxiliary portion;

FIG. 11(A) is a schematic front view illustrating the suction pad and the support portion used in the verification model illustrated in FIG. 10, FIG. 11(B) is a view illustrating a state in which one end of the target object is brought into contact with the auxiliary portion in the verification model, and FIG. 11(C) is a view illustrating a state in which the target object is separated from the suction pad;

FIG. 12 is a graph illustrating the relationship between the intersection angle and the allowable moment;

FIG. 13 is a table illustrating the relationship between the intersection angle and the allowable moment;

FIG. 14 is a view illustrating an example of the target object and a hand unit;

FIG. 15 is a graph illustrating a relationship between the allowable moment and a total length of the target object;

FIG. 16 is a view illustrating a state in which another target object is gripped by the suction pad;

FIG. 17 is a view illustrating a state in which still another target object is gripped by the suction pad;

FIG. 18(A) is a schematic view illustrating a state in which another target object is in a lying posture, and FIG. 18 (B) is a schematic view illustrating a state in which a part of another target object is brought into contact with the auxiliary portion;

FIG. 19 is an enlarged view illustrating a robot hand according to a first modification of the first embodiment;

FIG. 20 is an enlarged view illustrating a robot hand according to a second embodiment;

FIG. 21 is an enlarged view illustrating a robot hand according to a third embodiment;

FIG. 22 is an enlarged view illustrating an auxiliary portion of the robot hand and the target object according to a fourth embodiment;

FIG. 23 is a view illustrating a state in which an auxiliary portion of a robot hand of a fifth embodiment at its contact position is in contact with the target object in the lying posture; and

FIG. 24 is a view illustrating a state in which the auxiliary portion is moved to a non-contact position with respect to the target object in the lying posture.

### DETAILED DESCRIPTION

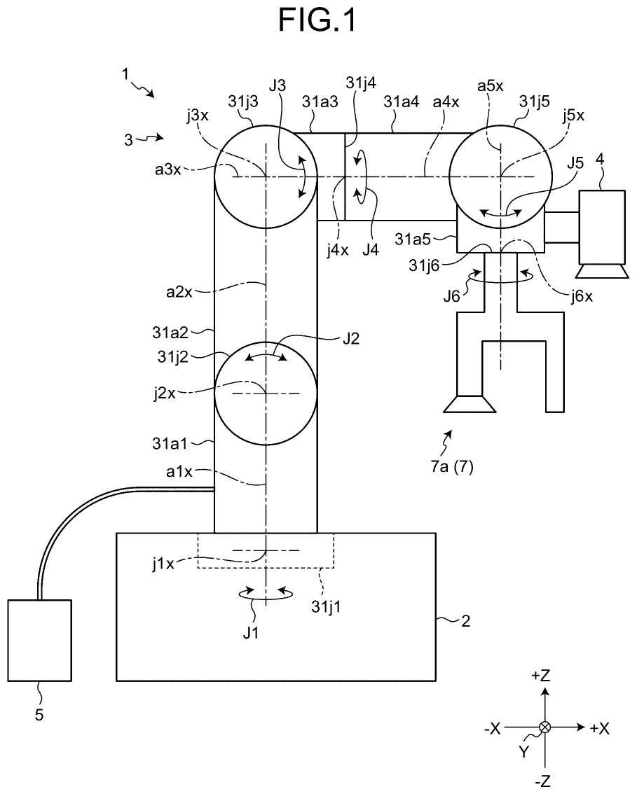

Hereinafter, a robot hand according to a first embodiment will be described with reference to FIGS. 1 to 14. Note that, in the present specification, components according to embodiments and descriptions of the components may be described using multiple expressions. The components and their description are just an example and are not limited by the expression of the present specification. The components may also be identified with names different from those in the present specification. In addition, the components may also be described by an expression different from the expression in the present specification.

### First Embodiment

First, a robot 1 including a robot hand 7 will be described. As illustrated in the drawings, in the present specification, an X axis, a Y axis, and a Z axis are defined for convenience. The X axis, the Y axis, and the Z axis are orthogonal to each other. The X axis is provided, for example, along a front-back direction of the robot 1. The Y axis is provided, for example, along a left-right direction of the robot 1. The Z axis is provided along a vertical direction.

Further, in the present specification, an X direction (front-back direction), a Y direction (left-right direction), and a Z direction (up-down direction) are defined. The X direction is a direction along the X axis, and includes a +X direction (forward direction) indicated by an arrow of the X axis and a −X direction (backward direction) which is a direction opposite to the arrow of the X axis. The Y direction is a direction along the Y axis, and includes a +Y direction (right direction) indicated by an arrow of the Y axis and a −Y direction (left direction) which is a direction opposite to the arrow of the Y axis. The Z direction is a direction along the Z axis, and includes a +Z direction (upward direction) indicated by an arrow of the Z axis and a −Z direction (downward direction) which is a direction opposite to the arrow of the Z axis.

FIG. 1 is a schematic configuration view of the robot 1 including the robot hand 7 according to the first embodiment. The robot 1 includes a pedestal 2, a moving mechanism 3, an imaging unit 4, a control unit 5, the robot hand 7, and a positive pressure source and a negative pressure source (not illustrated).

The robot 1 according to the present embodiment is a so-called six-axis articulated robot. More specifically, the robot 1 includes the moving mechanism 3 including multiple joint drive units 31j1, 31j2, 31j3, 31j4, 31j5, and 31j6 and multiple arms 31a1, 31a2, 31a3, 31a4, and 31a5. The robot 1 can move the robot hand 7 in the up-down direction, the left-right direction, and the front-rear direction orthogonal to each other by the moving mechanism 3.

The pedestal 2 is a rack on which the moving mechanism 3 is mounted, and is formed in, for example, a hollow rectangular parallelepiped shape.

The moving mechanism 3 includes a first joint drive unit 31j1, a second joint drive unit 31j2, a third joint drive unit 31j3, a fourth joint drive unit 31j4, a fifth joint drive unit 31j5, and a sixth joint drive unit 31j6. In addition, the moving mechanism 3 includes a first arm 31a1, a second arm 31a2, a third arm 31a3, a fourth arm 31a4, and a fifth arm 31a5.

The first joint drive unit 31j1 is provided at a proximal end of the first arm 31a1 and is embedded in the pedestal 2. The first joint drive unit 31j1 rotates the first arm 31a1 about an axis j1x (about an arrow J1 in FIG. 1) of the first joint drive unit 31j1 extending along the Z-axis direction with respect to the pedestal 2.

The first arm 31a1 is provided in a rod shape and extends along an axis a1x. The axis a1x is located along the Z-axis direction.

The second joint drive unit 31j2 is provided at a distal end of the first arm 31a1 and at a proximal end of the second arm 31a2. The second joint drive unit 31j2 swings the second arm 31a2 with respect to the first arm 31a1 about an axis j2x (about an arrow J2 in FIG. 1) of the second joint drive unit 31j2 extending along the Y-axis direction.

The second arm 31a2 is provided in a rod shape and extends along an axis a2x. The axis a2x is located along the Z-axis direction in the state illustrated in FIG. 1.

The third joint drive unit 31j3 is provided at a distal end of the second arm 31a2 and at a proximal end of the third arm 31a3. The third joint drive unit 31j3 swings the third arm 31a3 with respect to the second arm 31a2 about an axis j3x (about an arrow J3 in FIG. 1) of the third joint drive unit 31j3 extending along the Y-axis direction.

The third arm 31a3 is provided in a rod shape and extends along an axis a3x. The axis a3x is located along the X-axis direction in the state illustrated in FIG. 1.

The fourth joint drive unit 31j4 is provided at a distal end of the third arm 31a3 and at a proximal end of the fourth arm 31a4. The fourth joint drive unit 31j4 rotates the fourth arm 31a4 with respect to the third arm 31a3 about an axis j4x of the fourth joint drive unit 31j4 (about an arrow J4 in FIG. 1). For example, in the state illustrated in FIG. 1, the axis j4x of the fourth joint drive unit 31j4 extends along the X-axis direction.

The fourth arm 31a4 is provided in a rod shape and extends along an axis a4x. The axis a4x is located along the X-axis direction in the state illustrated in FIG. 1.

The fifth joint drive unit 31j5 is provided at a distal end of the fourth arm 31a4 and at a proximal end of the fifth arm 31a5. The fifth joint drive unit 31j5 swings the fifth arm 31a5 with respect to the fourth arm 31a4 about an axis j5x (about an arrow J5 in FIG. 1) of the fifth joint drive unit 31j5 extending along the Y-axis direction.

The fifth arm 31a5 is provided in a rod shape and extends along an axis a5x. The axis a5x is located along the Z-axis direction in the state illustrated in FIG. 1.

The sixth joint drive unit 31j6 is provided at a distal end of the fifth arm 31a5 and at a proximal end of the robot hand 7. The sixth joint drive unit 31j6 rotates the robot hand 7 with respect to the fifth arm 31a5 about an axis j6x of the sixth joint drive unit 31j6 (about an arrow J6 in FIG. 1). For example, in the state illustrated in FIG. 1, the axis j6x of the sixth joint drive unit 31j6 extends along the Z-axis direction.

The imaging unit 4 is, for example, a camera. The imaging unit 4 can continuously capture still images at a predetermined frame rate, for example, in response to a command from the control unit 5. The imaging unit 4 outputs still image data to the control unit 5 as an output signal in response to a command from the control unit 5.

Further, the imaging unit 4 is fixed to, for example, the fifth arm 31a5. An imaging direction of the imaging unit 4 can be changed by moving the fifth arm 31a5 in an appropriate direction by driving the moving mechanism 3 based on a command from the control unit 5. The control unit 5 moves a body portion 711 to be described later to an appropriate location corresponding to a target object 6 included in the still image acquired by the imaging unit 4.

The control unit 5 has a function of moving the robot hand 7 in the front-rear direction, the left-right direction, and the up-down direction by the moving mechanism 3 on the basis of data created in advance, gripping the target object 6, and moving the target object 6 from its initial position to a delivery position while changing the posture of the target object 6. At the time of movement of the target object 6, the control unit 5 has a function of controlling the moving mechanism 3, the positive pressure source, the negative pressure source, and a hand unit 7a to be described later. In other words, the control unit 5 has a function of controlling driving of the moving mechanism 3, the positive pressure source, and the negative pressure source of the robot 1, and also has a function of controlling the robot hand 7 gripping the target object 6.

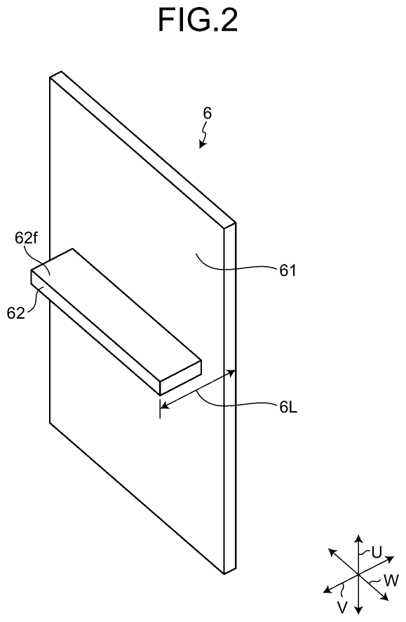

Next, the target object 6 will be described with reference to FIG. 2. FIG. 2 is a perspective view illustrating the target object 6 to be gripped by the robot hand 7. The target object 6 includes a target object body portion 61 and a protrusion portion 62.

The target object body portion 61 has, for example, a rectangular shape in a front view, and extends in a first direction (U axis). In other words, the first direction (U axis) indicates a direction in which the target object 6 extends. The target object body portion 61 is an example of a first member. The protrusion portion 62 protrudes from the target object body portion 61 in a second direction (V axis) intersecting the first direction (U axis). The protrusion portion 62 is an example of a second member. In the robot hand 7 according to the present embodiment, the protrusion portion 62 is a portion extending in the second direction (V axis) intersecting the first direction (U axis). The protrusion portion 62 has a suction surface 62f with which the body portion 711 to be described later comes into contact. The suction surface 62f is arranged on one side (upward direction) in the first direction.

The target object 6 is, for example, a chassis used for a product (structure), and the product (structure) is manufactured by assembling the chassis to another component. In addition, in the target object 6 according to the present embodiment, the first direction (U axis) and the second direction (V axis) are substantially orthogonal to each other. Note that, the first direction and the second direction in the target object 6 are not necessarily orthogonal to each other, and the first direction and the second direction have only to intersect each other. A third direction (W axis) orthogonal to the first direction and the second direction is, for example, a width direction of the target object 6. The size of the target object 6 in the second direction (V axis) is 6L. Further, in the target object 6 according to the present embodiment, the protrusion portion 62 protrudes in the second direction at the middle of the target object body portion 61 in the first direction.

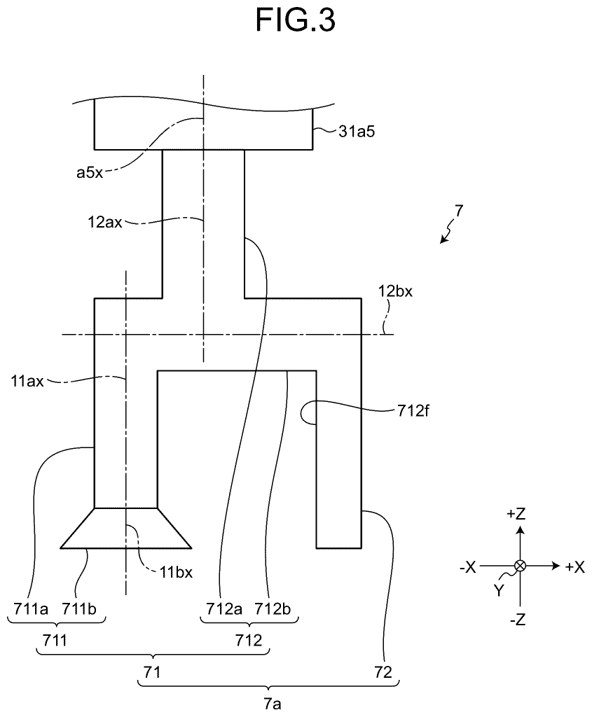

Next, the robot hand 7 will be described with reference to FIG. 3. FIG. 3 is an enlarged view of the robot hand 7 in the robot 1 illustrated in FIG. 1. As described above, the robot hand 7 is mounted on a distal end of the fifth arm 31a5, for example, and is movable in the up-down direction, the left-right direction, and the front-rear direction orthogonal to each other by the moving mechanism 3. The robot hand 7 described above includes the hand unit 7a that grips the target object 6, and the control unit 5 that controls the hand unit 7a.

The hand unit 7a includes a base portion 71 and an auxiliary portion 72. The base portion 71 includes the body portion 711 opposite the auxiliary portion 72 and a coupling portion 712 coupling the body portion 711 and the auxiliary portion 72. In the state illustrated in FIG. 3, the body portion 711 does not grip the target object 6, and the auxiliary portion 72 is opposed to the body portion 711 in the X-axis direction.

The body portion 711 includes a suction pad 711b that grips the target object 6 by sucking the protrusion portion 62 protruding from the target object 6, and a support portion 711a that supports the suction pad 711b.

The support portion 711a extends along an axis 11ax and is formed in a rod shape. In the state illustrated in FIG. 3, the axis 11ax extends along the Z axis.

The suction pad 711b is formed in, for example, a cylindrical shape in which a diameter on a side close to the support portion 711a is small and the diameter increases with distance from the support portion 711a, and is connected to the positive pressure source and the negative pressure source via piping (not illustrated).

The number of the body portions 711 corresponding to a length along the width direction of the target object 6 (the length in the W-axis direction which is the third axis direction in FIG. 2) is provided in the robot hand 7. For example, when the length of the target object 6 in the width direction is long, the multiple body portions 711 are arranged in the hand unit 7a along the third direction. On the other hand, when the length of the target object 6 in the width direction is short, for example, one body portion 711 is provided in the hand unit 7a.

As will be described later, the robot hand 7 described above can grip the target object 6 by driving the negative pressure source in a state where a distal end of the suction pad 711b is pressed against the suction surface 62f of the protrusion portion 62 and thereby sucking the air inside the suction pad 711b and reducing the air pressure inside the suction pad 711b.

On the other hand, the robot hand 7 can release the target object 6 from the gripping state by driving the positive pressure source in a state of gripping the target object 6 and thereby discharging the air to the inside of the suction pad 711b and increasing the air pressure inside the suction pad 711b.

The coupling portion 712 is formed in a substantially T shape having, for example, a coupling body portion 712a and a branch portion 712b that is provided at a distal end of the coupling body portion 712a and branches into two.

The coupling body portion 712a is formed in, for example, a rod shape extending along an axis 12ax. The coupling body portion 712a is attached to the distal end of the fifth arm 31a5 so that, for example, the axis 12ax of the coupling body portion 712a and the axis a5x of the fifth arm 31a5 coincide with each other. In the state illustrated in FIG. 3, the axis 12ax extends along the Z axis.

The branch portion 712b is formed in a rod shape so as to extend along an axis 12bx, and is arranged at a distal end of the coupling body portion 712a. The body portion 711 is arranged at one end of the branch portion 712b, and the auxiliary portion 72 is arranged at the other end of the branch portion 712b. In the state illustrated in FIG. 3, the axis 12bx extends along the X axis.

In the state illustrated in FIG. 3, the auxiliary portion 72 is formed in a rectangular plate shape when viewed in the front-rear direction. The auxiliary portion 72 according to the present embodiment is integrally formed of the same material. In addition, the auxiliary portion 72 has an opposed surface 712f orthogonal to the front-rear direction in the state illustrated in FIG. 3 on the side opposed to the body portion 711. In the front-back direction in which the body portion 711 of the robot hand 7 and the auxiliary portion 72 are opposed to each other in the state illustrated in FIG. 3, the distance in the X-axis direction between an axis 11bx of the suction pad 711b and the auxiliary portion 72 is LA. Note that, in the robot hand 7 illustrated in the present embodiment, the auxiliary portion 72 is arranged on the right side and the body portion 711 is arranged on the left side in FIG. 3. In addition, in the robot hand 7 according to the present embodiment, the support portion 711a, the coupling portion 712, and the auxiliary portion 72 are integrally formed of the same material. Note that, the auxiliary portion 72 is not limited to one formed in a plate shape using the same material, and for example, may be formed by arranging multiple columnar members along the left-right direction (Y-axis direction), or may be formed by arranging members having another shape along the left-right direction.

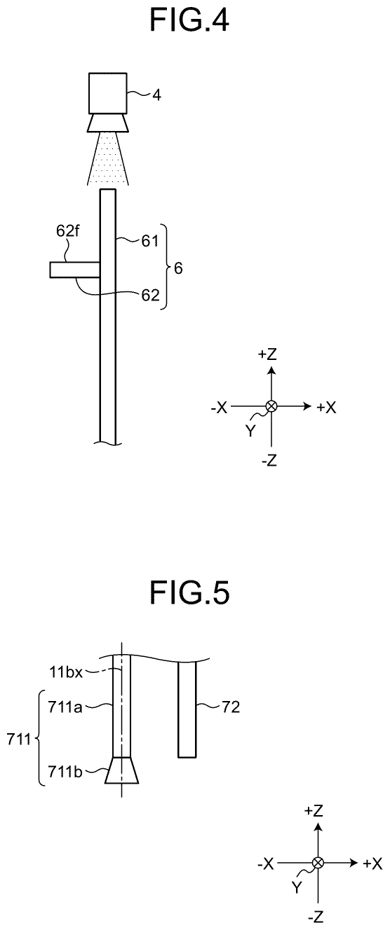

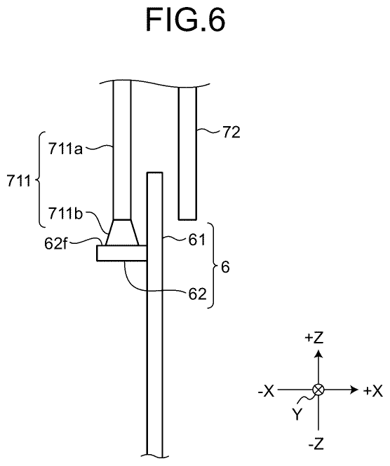

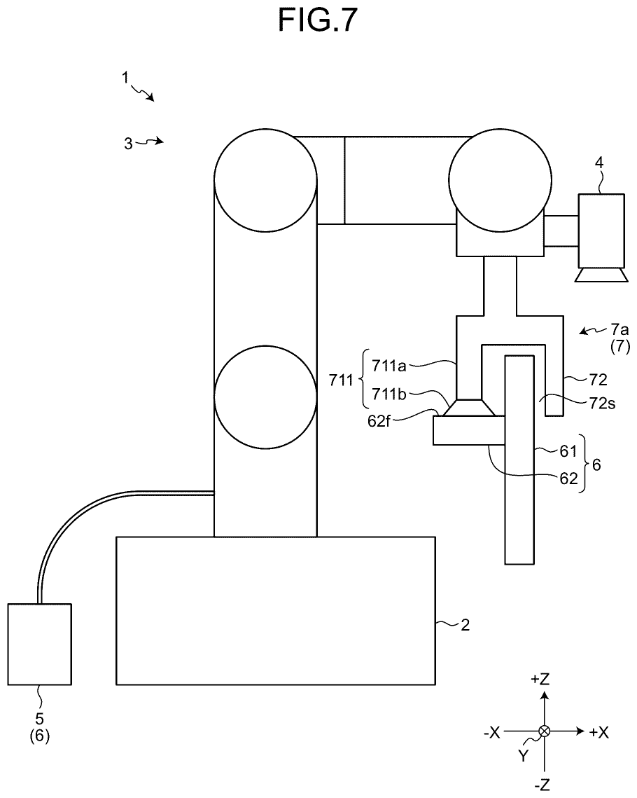

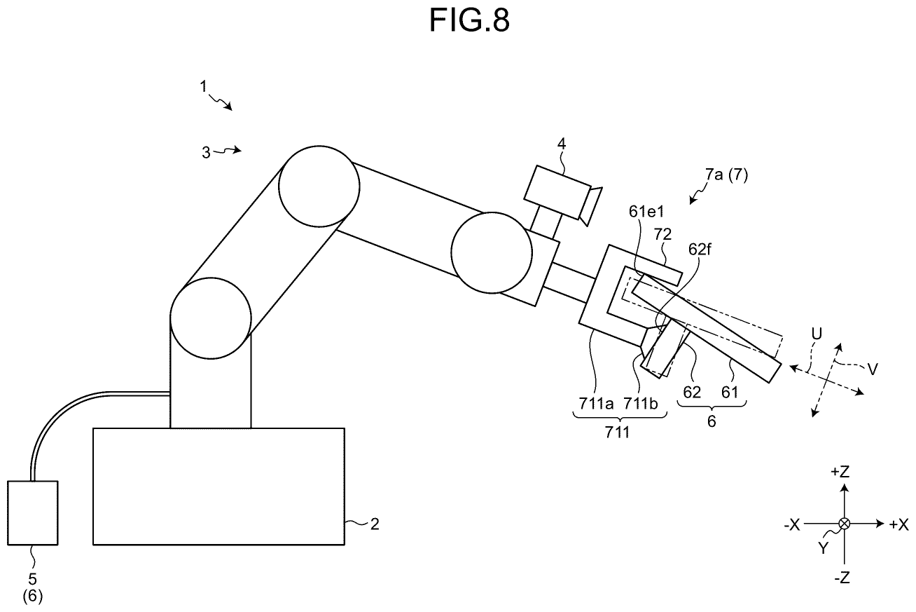

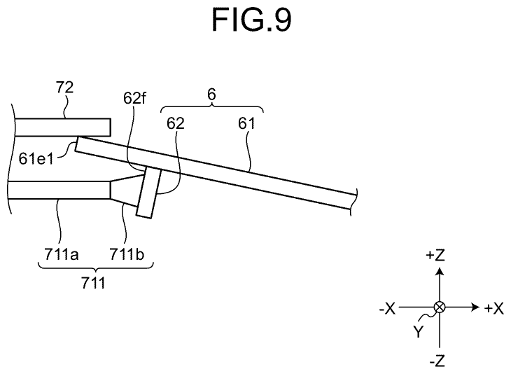

Next, a case where the robot 1 and the robot hand 7 having the above configuration grip the target object 6 and change the posture of the target object 6 will be described with reference to FIGS. 1, 4, 5, 6, 7, 8, and 9. FIG. 4 is a view illustrating a state in which the imaging unit 4 included in the robot 1 recognizes a position of the target object 6. FIG. 5 is a view illustrating a state in which the robot hand 7 is moved above the target object 6. FIG. 6 is a schematic view illustrating a state in which the distal end of the suction pad 711b is brought into contact with the protrusion portion 62 of the target object 6. FIG. 7 is a schematic view illustrating a state in which the robot hand 7 grips the target object 6 in a standing posture. FIG. 8 is a schematic view illustrating a state in which the robot hand 7 grips the target object 6 in a lying posture. FIG. 9 is a partially enlarged view illustrating the state in which the robot hand 7 grips the target object 6 in the lying posture.

First, from the initial state illustrated in FIG. 1, for example, the target object 6 is arranged in the vicinity of the robot 1 by a conveyance unit such as a belt conveyor.

Next, the control unit 5 acquires a still image by the imaging unit 4, and grasps the position of the target object 6 illustrated in FIG. 4 using the acquired still image.

Next, as illustrated in FIG. 5, the control unit 5 drives the moving mechanism 3 so that the body portion 711 is positioned above the protrusion portion 62 of the target object 6.

Next, the control unit 5 drives the moving mechanism 3 to move the body portion 711 downward, and presses the distal end of the suction pad 711b against the suction surface 62f of the protrusion portion 62 as illustrated in FIG. 6.

Next, the control unit 5 drives the negative pressure source to suck the air inside the suction pad 711b and reduce the air pressure inside the suction pad 711b, thereby gripping the target object 6 with the suction pad 711b as illustrated in FIG. 7 (initial gripping state).

In the initial gripping state, for example, the first direction (U axis) of the target object 6 coincides with the up-down direction (Z axis) of the robot 1 and the robot hand 7, the second direction (V axis) of the target object 6 coincides with the front-rear direction (X axis) of the robot 1 and the robot hand 7, and the third direction (W axis) of the target object 6 coincides with the left-right direction (Y axis) of the robot 1 and the robot hand 7. In this initial gripping state, the target object 6 is in a standing posture in which the first direction (U axis) is along the Z axis which is the up-down direction.

In the initial gripping state (the state in which the target object 6 in a standing posture is held by the suction pad 711b), a space portion 72s is interposed between the auxiliary portion 72 and the target object 6. More specifically, the space portion 72s is interposed between the auxiliary portion 72 and the target object body portion 61 in the front-back direction (X axis) in the initial gripping state. In other words, the auxiliary portion 72 is in a state of not being in contact with the target object 6 in a standing posture. In addition, the robot hand 7 according to the present embodiment includes the suction pad 711b that sucks the protrusion portion 62 of the target object 6 to grip the target object 6, and the auxiliary portion 72 that is provided so as to be opposed to the body portion 711 in a state of gripping the target object 6.

Next, the control unit 5 drives the moving mechanism 3 so as to bring the moving mechanism 3 into a lying posture in which the first direction (U axis) of the target object 6 is inclined with respect to the up-down direction (Z axis) and the second direction (V axis) of the target object 6 is inclined with respect to the front-rear direction (X axis) as illustrated in FIG. 8.

In a case where the target object 6 is in a lying posture, the target object 6 rotates, for example, about a rotation center of the target object 6 to be described later as indicated by a solid line in FIG. 8 by the action of gravity, and as illustrated in FIG. 9, one end 61e1 of the target object body portion 61 in the first direction (U axis) comes into contact with the auxiliary portion 72, so that the rotation of the target object 6 is restricted (gripping rotation restricted state). Note that, the rotation center of the target object 6 in the present embodiment is an intersection of the suction surface 62f of the target object 6 and the axis 11bx of the suction pad 711b. The auxiliary portion 72 is in contact with (contact state) the target object 6 in the lying posture. In this contact state, the target object 6 is prevented from moving in the X-axis direction and being separated from the suction pad 711b by a static frictional force generated at a contact point between the target object 6 and the auxiliary portion 72.

Finally, for example, by driving the positive pressure source to increase the air pressure inside the suction pad 711b, the control unit 5 releases the target object 6 gripped by the body portion 711 from the gripping rotation restricted state, places the target object 6 in the lying posture on a belt conveyor for example, and ends a series of operations of the robot 1 and the robot hand 7.

Thereafter, an operator or an assembly robot manufactures a structure in which the target object 6 in the lying posture is assembled to another component.

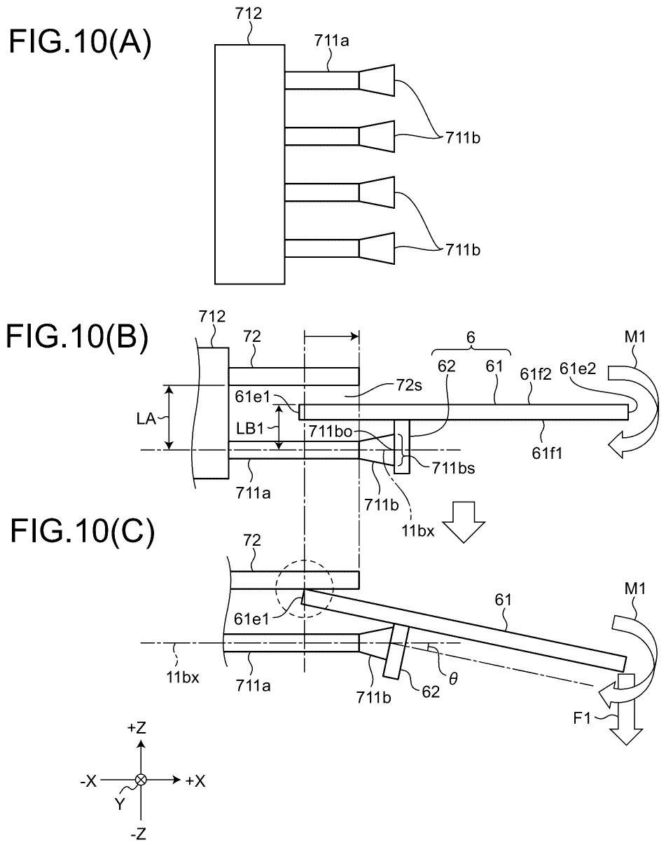

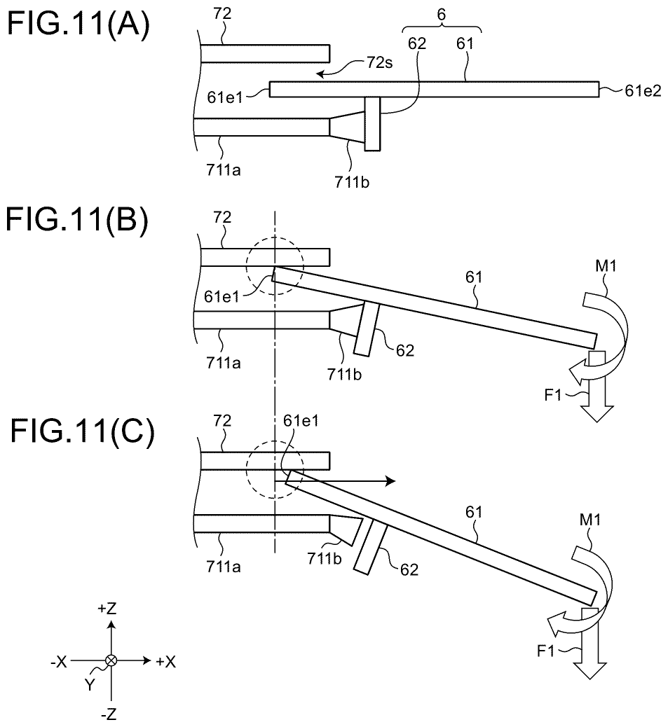

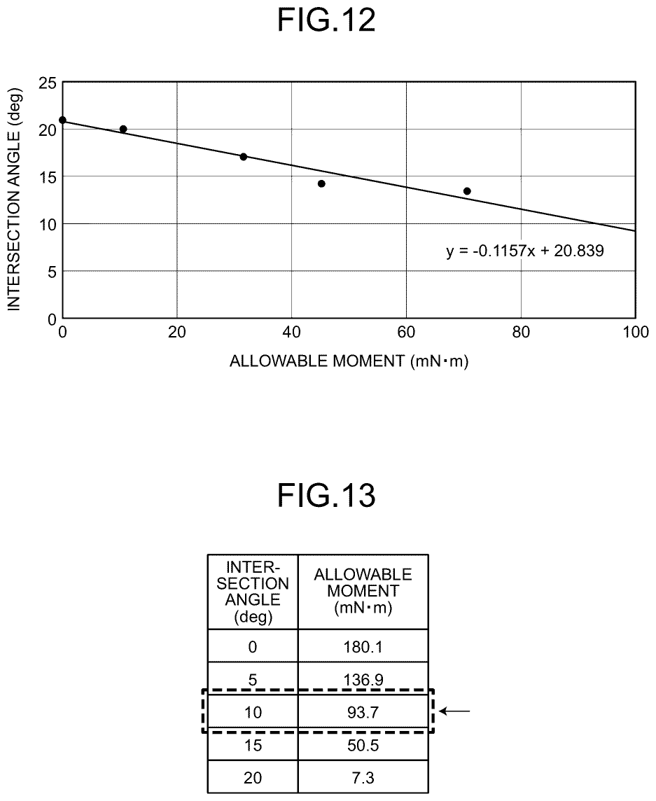

Next, regarding the robot hand 7 according to the present embodiment, an intersection angle and an allowable moment to be described later will be described with reference to FIGS. 10, 11, 12, and 13. FIG. 10(A) is a schematic plan view illustrating the suction pad 711b and the support portion 711a used in a verification model for verifying a relationship between the intersection angle and the allowable moment, FIG. 10(B) is a schematic front view of the suction pad 711b and the auxiliary portion 72 used in the verification model, and FIG. 10(C) is a view illustrating a state in which a part of the target object 6 is brought into contact with the auxiliary portion 72. FIG. 11(A) is a schematic front view illustrating the suction pad 711b and the support portion 711a used in the verification model illustrated in FIG. 10, FIG. 11(B) is a view illustrating a state in which the one end 61e1 of the target object 6 is brought into contact with the auxiliary portion 72 in the verification model, and FIG. 11(C) is a view illustrating a state in which the target object 6 is separated from the suction pad 711b. FIG. 12 is a graph illustrating the relationship between the intersection angle and the allowable moment. FIG. 13 is a table illustrating the relationship between the intersection angle and the allowable moment.

In the following description, verification is performed using a simple verification model. For example, as illustrated in FIG. 10 (A), the body portion 711 used here includes the four support portions 711a and the four suction pads 711b, and a moment M1 and a force F1 are applied to the target object 6 and the suction pads 711b by hanging a weight from the target object 6 extending in the X-axis direction. In this event, as illustrated in FIG. 10 (B), a distance LA between the axis 11bx of the suction pad 711b and the auxiliary portion 72 in the Z-axis direction is set to be larger than a distance LB1 in the Z-axis direction from the axis 11bx of the suction pad 711b to a second surface (surface) 61f2 of the target object body portion 61 on the side opposite to a first surface (surface) 61f1 brought into contact with the protrusion portion 62. At this time, a weight is hung from the other end 61e2 in a longitudinal direction of the target object body portion 61, and the posture of the target object 6 is changed by gravity acting on the weight as illustrated in FIG. 10 (C), and the one end 61e1 of the target object 6 and the auxiliary portion 72 are brought into contact with each other. Then, after the one end 61e1 and the auxiliary portion 72 are brought into contact with each other, in a case where a weight is further added to the other end 61e2 and therefore the one end 61e1 starts to deviate from the auxiliary portion 72 in the +X direction in the X-axis direction as illustrated in FIG. 11 (C), it is assumed that the target object 6 is separated from the suction pad 711b, and the moment M1 is calculated based on the weight of the weight immediately before the separation. Here, an intersection angle θ is an angle formed by the axis 11bx of the suction pad 711b and the first direction (U-axis direction: see FIG. 8) in which the target object body portion 61 extends. Then, by changing the size of the space portion 72s in the Z-axis direction, the intersection angle θ is changed, and the correlation between the allowable moment M1 of the target object 6 and the intersection angle θ is calculated. The results are illustrated in FIGS. 12 and 13.

In the verification model, the robot hand 7 including the four suction pads 711b is used. The size of the target object 6 used in the verification model is 132 mm in the first direction and 166 mm in the third direction. In addition, the weight of the target object 6 is 130 g. Further, the target object 6 is gripped using the four suction pads 711b with the vacuum pressure of each suction pad 711b set to −83 kpa.

As illustrated in FIGS. 12 and 13, when the intersection angle θ is small, the allowable moment is large, and when the intersection angle θ is large, the allowable moment is small; in this way, the intersection angle θ and the allowable moment are in a proportional relationship. When the vertical axis represents the intersection angle [y] and the horizontal axis represents the allowable moment [x] per suction pad 711b (In other words, per unit suction pad), the following equation holds.

y=−0.1157x+20.839 (1)

Note that, in the graph illustrated in FIG. 12, a lower region in the Y-axis direction in the equation (1) is a region where the target object 6 can be gripped by the suction pad 711b.

This verification model shows that, if the intersection angle θ is limited to 10 degrees or less, one suction pad can withstand up to 93.7 [mN·m] (vacuum breakdown to be described later can be prevented). In other words, when the hand unit 7a according to the present embodiment grips the target object 6 in the lying posture, the intersection angle θ formed by the axis 11bx of the suction pad 711b and the first direction (U-axis direction) in which the target object body portion 61 extends is preferably 10 degrees or less.

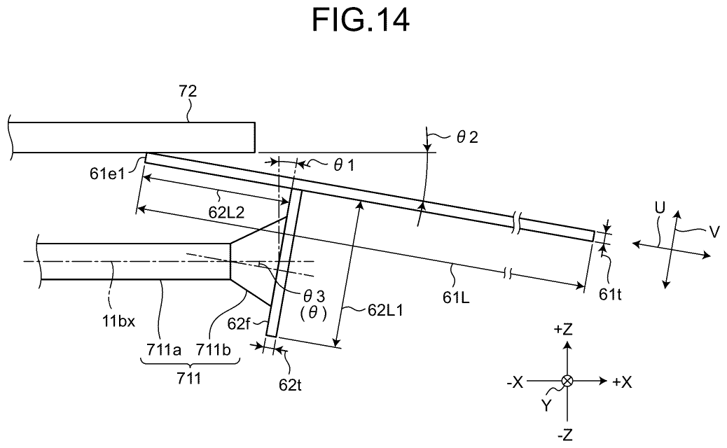

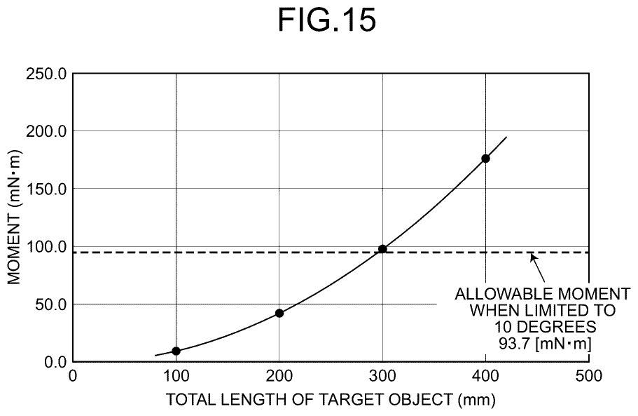

Next, specifications of the target object 6 and the hand unit 7a are examined using the target object 6 used for the robot hand 7. The examination of these specifications will be described with reference to FIGS. 14 and 15. FIG. 14 is a view illustrating an example of the target object 6 and the hand unit 7a. FIG. 15 is a graph illustrating the relationship between the moment and the overall length (that is, the length of the target object 6 in the first direction) of the target object 6.

The specifications of the body portion 711 illustrated in FIG. 14 are as follows. The body portion 711 is provided with one suction pad 711b, and the pressure inside the suction pad 711b is −83 kPa. The diameter of the suction pad 711b is 10 mm.

Meanwhile, the specifications of the target object 6 illustrated in FIG. 14 are as follows. The target object 6 is made of iron having a density of 7.8 g/cm³. The width of the target object 6 in the third direction (W axis) is 30 mm. In other words, in this verification, it is examined whether the target object 6 having a width of 30 mm can be gripped by one suction pad 711b. A thickness 61t of the target object body portion 61 is 1 mm. A thickness 62t of the protrusion portion 62 is 1 mm. A length 62L1 of the protrusion portion 62 in the second direction (V axis) is 15 mm. In the first direction (U axis), a length 62L2 from the position where the protrusion portion 62 is provided to the one end 61e1 of the target object body portion 61 is 15 mm.

FIG. 15 illustrates a result of examining a length 61L, which is a length in the first direction (U axis) of the target object 6 illustrated in FIG. 14, that can be gripped without causing vacuum breakdown to be described later by changing the length 61L.

As described above, in a case where the intersection angle θ is set to 10 degrees, when the length 61L of the target object 6 in the first direction is 300 mm, a moment of about 94 [mN·m] is applied to the suction pad 711b. With this degree of moment, the suction pad 711b can grip the target object 6 without causing vacuum breakdown. In other words, the target object 6 can be gripped in a region below 94 [mN·m] with respect to the moment on the vertical axis of the graph illustrated in FIG. 15.

To summarize the above verification result, when the hand unit 7a according to the present embodiment grips the target object 6 in the standing posture, the axis 11bx of the suction pad 711b and the suction surface 62f of the protrusion portion 62 are preferably substantially orthogonal to each other, and when the hand unit grips the target object 6 in the lying posture, the intersection angle θ formed by the axis 11bx of the suction pad 711b and the first direction (U-axis direction) in which the target object body portion 61 extends is preferably 10 degrees or less. The length of the target object 6 in the first direction (U axis), which is the longitudinal direction, is preferably 300 mm or less. Further, in order to set the intersection angle θ to 10 degrees, the distance LA in the Z-axis direction between the axis 11bx of the suction pad 711b and the auxiliary portion 72 is preferably approximately 11 mm.

Note that, in the state illustrated in FIG. 14, since the auxiliary portion 72 and the axis 11bx of the suction pad 711b are parallel to each other, an intersection angle θ3 formed by the axis 11bx of the suction pad 711b and the first direction (U axis) of the target object 6 is a corresponding angle of an intersection angle θ2 formed by the auxiliary portion 72 and the first direction (U-axis direction) in which the target object body portion 61 extends, so that the intersection angle θ3 and the intersection angle θ2 are the same. In addition, an intersection angle θ1 formed by a perpendicular line with respect to the axis 11bx of the suction pad 711b and the suction surface 62f of the protrusion portion 62 is the same as the intersection angle θ3 because the target object body portion 61 and the protrusion portion 62 are at a right angle.

As illustrated in FIG. 14, the hand unit 7a of the robot hand 7 according to the present embodiment includes: the body portion 711 including the suction pad 711b that sucks the protrusion portion 62 (second member) protruding from the target object body portion 61 (first member) in the second direction (V axis) intersecting the first direction, indicating a direction (U axis) in which the target object 6 extends, to grip the target object 6 and the support portion 711a that supports the suction pad 711b; and the auxiliary portion 72 provided so as to be opposed to the body portion 711 in a state where the suction pad 711b grips the target object 6. The distance LA between the axis 11bx of the suction pad 711b and the auxiliary portion 72 in the Z-axis direction is larger than the distance LB1 in the Z-axis direction from the axis 11bx of the suction pad 711b to the second surface (surface) 61f2 of the target object body portion 61 on the side opposite to the first surface (surface) 61f1 brought into contact with the protrusion portion 62. Thus, in the initial gripping state in which the robot hand 7 grips the target object 6, the target object 6 and the auxiliary portion 72 are in non-contact with each other; on the other hand, when the posture of the target object 6 is changed, the target object 6 rotates by the action of gravity and the end of the target object body portion 61 comes into contact with the auxiliary portion 72. As a result, the robot hand 7 can restrict the rotation of the target object 6, thus making it possible to suppress separation of the gripped target object 6 from the suction pad 711b. In addition, by moving one arm member with respect to the other arm member by driving the motor, it is possible to reduce a region required to grip the target object 6 as compared with a conventional robot hand that clamps a target object with one arm member and the other arm member.

In the robot hand 7 according to the present embodiment, by providing the auxiliary portion 72 that limits the rotational moment of the target object 6 in the hand unit 7a, it is possible to suppress entry of external air into the body portion 711 due to the rotation of the target object 6 (vacuum breakdown), thereby suppressing separation of the target object 6 from the hand unit 7a.

In the robot hand 7 according to the present embodiment, the hand unit 7a is provided in the robot 1 so as to be capable of gripping the target object 6 in the standing posture and changing the posture of the target object 6 from the standing posture to the lying posture, and the auxiliary portion 72 is in non-contact with the target object 6 in the standing posture but capable of being in contact with the target object 6 in the lying posture. More specifically, in the robot hand 7, by changing the posture of the target object 6, the target object 6 rotates by the action of gravity, and the one end 61e1 of the target object body portion 61 comes into contact with the auxiliary portion 72, so that the rotation of the target object 6 can be restricted.

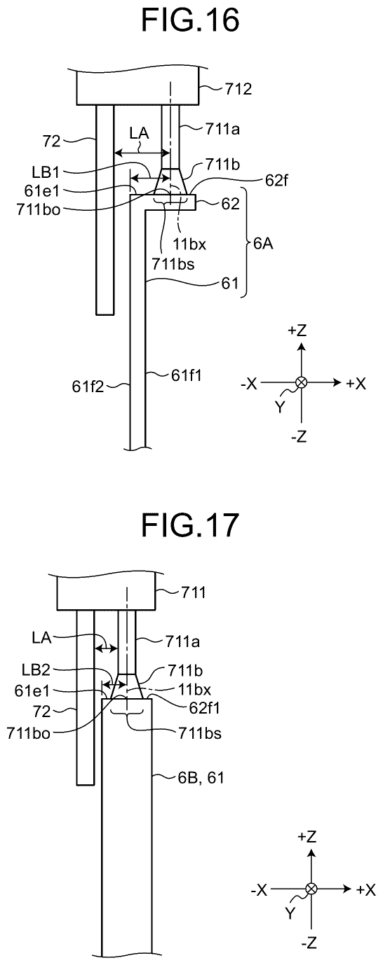

Next, another target object 6A gripped by the robot hand 7 according to the present embodiment will be described with reference to FIG. 16. FIG. 16 is a view illustrating a state in which another target object 6A is gripped by the suction pad 711b.

In the target object 6A illustrated in FIG. 16, the protrusion portion 62 protrudes in the second direction at the end of the target object body portion 61 in the first direction. Since the configuration of the hand unit 7a in FIG. 16 is the same as the above configuration, it is not described here.

After the hand unit 7a grips the target object 6 in the standing posture, the control unit 5 drives the moving mechanism 3 to change the posture of the target object 6 to the lying posture. When the one end 61e1 of the target object body portion 61 comes into contact with the auxiliary portion 72, the rotation is restricted.

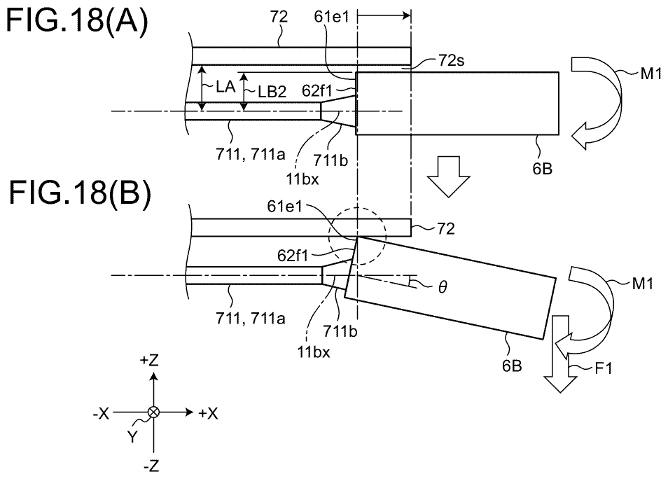

Next, another target object 6B gripped by the robot hand 7 according to the present embodiment will be described with reference to FIGS. 17 and 18. FIG. 17 is a view illustrating a state in which still another target object 6B is gripped by the suction pad 711b. In the example of FIG. 17, the target object 6B includes the target object body portion 61 without the above protrusion portion 62. In the example of FIG. 17, the target object body portion 61 is formed in a rectangular parallelepiped shape. FIG. 18(A) is a schematic view illustrating a state in which the target object 6B is in a lying posture, and FIG. 18(B) is a schematic view illustrating a state in which a part of the target object 6B in the lying posture is brought into contact with the auxiliary portion 72. Since the configuration of the hand unit 7a in FIGS. 17 and 18 is the same as the above configuration, it is not described here.

The suction pad 711b grips the target object 6B by sucking an upper surface 62f1 of the target object 6B. The upper surface 62f1 is an example of a “surface”. The upper surface 62f1 is an end surface of the target object 6B in the +Z direction and corresponds to the suction surface 62f.

As illustrated in FIG. 17, in a state where the target object 6B is in a standing posture and the suction pad 711b grips the target object 6B, the distance LA between the axis 11bx of the suction pad 711b and the auxiliary portion 72 in the Z-axis direction is larger than a distance LB2, in a direction in which the body portion 711 and the auxiliary portion 72 are opposed to each other, from the axis 11bx of the suction pad 711b to an end of the upper surface 62f1 in the upper surface 62f1 of the target object 6B.

As described above, after the hand unit 7a grips the target object 6B in the standing posture, the control unit 5 drives the moving mechanism 3 to change the posture of the target object 6B to the lying posture as illustrated in FIG. 18 (A). Then, as illustrated in FIG. 18 (B), when the one end 61e1 of the target object 6B comes into contact with the auxiliary portion 72, the rotation of the target object 6B is restricted.

Even in this example, similarly to the above embodiment, the robot hand 7 can limit the rotation of the target object 6B. Thus, it is possible to suppress separation of the gripped target object 6B from the suction pad 711b.

### First Modification of First Embodiment

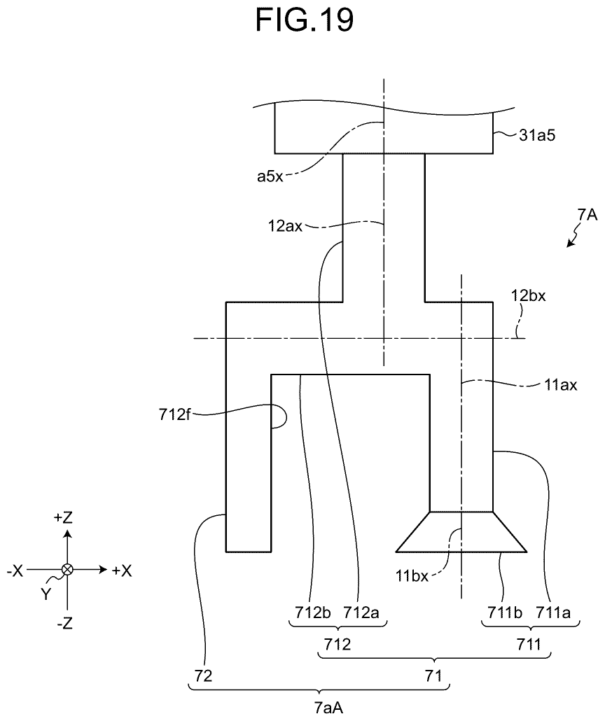

Next, a robot hand 7A according to a first modification of the first embodiment will be described with reference to FIG. 19. FIG. 19 is an enlarged view illustrating the robot hand 7A according to the first modification of the first embodiment. In the configuration of the robot hand 7A according to the first modification of the first embodiment, the same components as those of the robot hand 7 according to the first embodiment are denoted by the same reference numerals and will not be described, and different components will be described below.

The robot hand 7A according to the present modification includes a hand unit 7aA. In addition, in the robot hand 7A according to the present modification, the auxiliary portion 72 is arranged on the left side and the body portion 711 is arranged on the right side in FIG. 19.

Note that, FIGS. 3 and 19 illustrate the robot hands 7 and 7A in which the body portion 711 is arranged on one side in the front-rear direction and the auxiliary portion 72 is arranged on the other side in the front-rear direction. However, the robot hands 7 and 7A according to the present embodiment are not limited to this. For example, the robot hands 7 and 7A may be configured so that the body portion 711 is arranged on one side in the left-right direction and the auxiliary portion 72 is arranged on the other side in the left-right direction.

### Second Embodiment

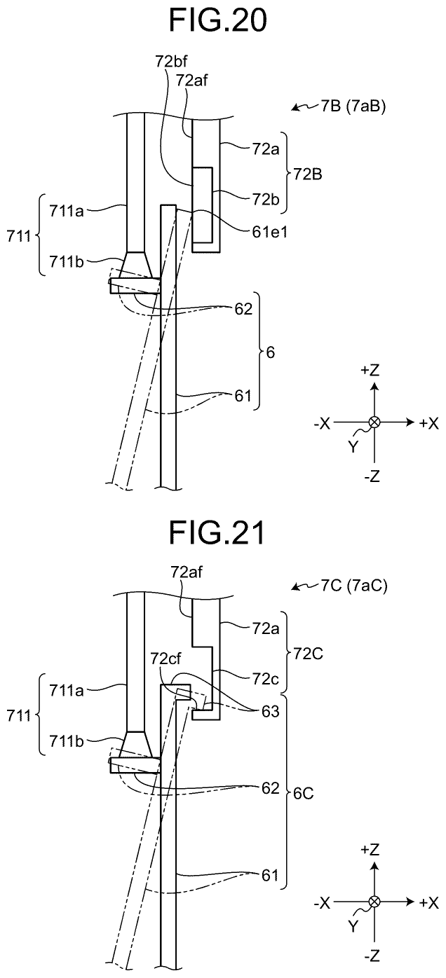

Next, a robot hand 7B according to a second embodiment will be described with reference to FIG. 20. FIG. 20 is an enlarged view illustrating the robot hand 7B according to the second embodiment. Note that, in FIG. 20, the target object 6 in a standing posture is indicated by a solid line, and the target object 6 in a lying posture is indicated by an imaginary line. In addition, in the configuration of the robot hand 7B according to the second embodiment, the same components as those of the robot hand 7 according to the first embodiment are denoted by the same reference numerals and will not be described, and different components will be described below.

The robot hand 7B according to the present embodiment includes a hand unit 7aB. In addition, an auxiliary portion 72B according to the present embodiment includes a base 72a and a movement restriction portion 72b formed of a material having a static friction coefficient larger than the static friction coefficient of the material forming the base 72a.

The base 72a is formed of, for example, metal. On the other hand, the movement restriction portion 72b is formed in a three-dimensional shape such as a block shape by rubber, silicon, or the like, for example. In the hand unit 7aB, the movement restriction portion 72b formed in a three-dimensional shape is provided at the base 72a by, for example, embedding the movement restriction portion 72b in a recess formed at the base 72a. Note that, the movement restriction portion 72b is not limited to one formed in a three-dimensional shape. For example, the movement restriction portion 72b may be formed in a sheet shape, and may be provided on the base 72a by attaching the movement restriction portion 72b to a surface of the base 72a.

In addition, in the auxiliary portion 72B according to the present embodiment, a surface 72af of the base 72a and a surface 72bf of the movement restriction portion 72b constitute the same plane.

Further, the auxiliary portion 72B according to the present embodiment is in non-contact with the target object 6 in a standing posture. On the other hand, when the moving mechanism 3 is driven to displace the target object 6 to the lying posture after the target object 6 is gripped, the target object 6 becomes in contact with the movement restriction portion 72b (contact state). In this contact state, the target object 6 is prevented from moving in the Z-axis direction by a static frictional force generated at a contact point between the target object 6 and the movement restriction portion 72b.

In the robot hand 7B according to the present embodiment, the auxiliary portion 72B includes the base 72a and the movement restriction portion 72b formed of a material having a static friction coefficient larger than the static friction coefficient of the material forming the base 72a, and while the auxiliary portion 72B is in non-contact with the target object 6 in the standing posture, the movement restriction portion 72b is capable of being in contact with the target object 6 in the lying posture. Thus, for example, the effect of preventing the target object 6 from moving in the Z-axis direction can be improved as compared with the movement restriction portion formed of a metal material.

### Third Embodiment

Next, a robot hand 7C according to a third embodiment will be described with reference to FIG. 21. FIG. 21 is an enlarged view illustrating the robot hand 7C according to the third embodiment. Note that, in FIG. 21, a target object 6C in a standing posture is indicated by a solid line, and the target object 6C in a lying posture is indicated by an imaginary line. In addition, in the configuration of the robot hand 7C according to the third embodiment, the same components as those of the robot hand 7 according to the first embodiment are denoted by the same reference numerals and will not be described, and different components will be described below.

The target object 6C has a second protrusion portion 63 formed at a position different from the protrusion portion 62. More specifically, the second protrusion portion 63 protrudes, in the second direction, in a direction opposite to the direction in which the protrusion portion 62 protrudes from the target object body portion 61. The second protrusion portion 63 according to the present embodiment is arranged at an upper end in the up-down direction of the target object body portion 61 when viewed from the left-right direction, and is formed in a rectangular parallelepiped shape. The second protrusion portion 63 is an example of a third member.

The robot hand 7C according to the present embodiment includes a hand unit 7aC. In addition, an auxiliary portion 72C according to the present embodiment includes the base 72a and a recess portion 72c formed at the base 72a. In the auxiliary portion 72C according to the present embodiment, for example, the base 72a and the recess portion 72c are integrally formed of the same material.

The recess portion 72c is formed so as to be recessed from the surface 72af of the base 72a. More specifically, in the state illustrated in FIG. 21, the recess portion 72c is recessed so as to be away from the body portion 711 in the front-rear direction.

Further, the auxiliary portion 72C according to the present embodiment is in non-contact with the target object 6C in a standing posture. On the other hand, when the moving mechanism 3 is driven to displace the target object 6C to the lying posture after the target object 6C is gripped, the second protrusion portion 63 of the target object 6C is fitted into the recess portion 72c, and the second protrusion portion 63 comes into contact with an inner surface 72cf of the recess portion 72c. In the contact state where the inner surface 72cf of the recess portion 72c and the second protrusion portion 63 are in contact with each other, the target object 6C is prevented from moving in the Z-axis direction by a static frictional force generated at a contact point between the inner surface 72cf and the second protrusion portion 63.

In the robot hand 7C according to the present embodiment, the hand unit 7aC is provided in the robot 1 so as to be capable of gripping the target object 6C in the standing posture and capable of changing the posture of the target object 6C from the standing posture to the lying posture. Then, by changing the posture of the target object 6C, the target object 6C rotates by the action of gravity and the second protrusion portion 63 is fitted into the recess portion 72c, so that the rotation of the target object 6C can be restricted.

In the robot hand 7C according to the present embodiment, the auxiliary portion 72C has the recess portion 72c into which the second protrusion portion 63 of the target object 6C is fitted. Thus, the hand unit 7aC can grip the target object 6C having the second protrusion portion 63 protruding from the target object body portion 61 in the direction opposite to the protrusion portion 62 in the second direction (V axis).

### Fourth Embodiment

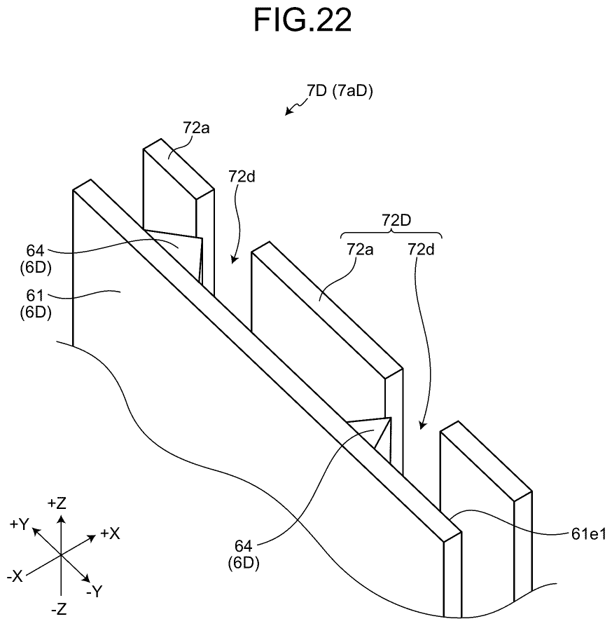

Next, a robot hand 7D according to a fourth embodiment will be described with reference to FIG. 22. FIG. 22 is an enlarged view illustrating an auxiliary portion 72D of the robot hand 7D and a target object 6D according to the fourth embodiment. Note that, in the configuration of the robot hand 7D according to the fourth embodiment, the same components as those of the robot hand 7 according to the first embodiment are denoted by the same reference numerals and will not be described, and different components will be described below.

The target object 6D has a third protrusion portion 64 formed at a position different from the protrusion portion 62. More specifically, the third protrusion portion 64 protrudes, in the second direction, in a direction opposite to the direction in which the protrusion portion 62 protrudes from the target object body portion 61. The third protrusion portion 64 according to the present embodiment is formed in, for example, a triangular prism shape and extends in the up-down direction. In other words, the third protrusion portion 64 is formed in a triangular shape when viewed from the up-down direction, and is formed in a quadrangular shape when viewed from the third direction. The third protrusion portion 64 is an example of a fourth member.

The robot hand 7D according to the present embodiment includes a hand unit 7aD. In addition, the auxiliary portion 72D according to the present embodiment includes a first portion 72a with which the target object body portion 61 of the target object 6D comes into contact when the moving mechanism 3 is driven to displace the target object 6D to the lying posture, and a second portion (for example, a slit 72d) into which the third protrusion portion 64 is inserted. The second portion may be the slit 72d or a hole. Further, the first portion 72a may be, for example, multiple dividing walls obtained by dividing the auxiliary portion 72D, and the second portion may be a space between the dividing walls. FIG. 22 is a diagram illustrating an example of a case where the second portion is the slit 72d. In the second portion illustrated in FIG. 22, multiple slits 72d recessed in the −Z direction from one end of the auxiliary portion 72D located in the +Z direction of the Z-axis direction are formed in the Y-axis direction. Note that, the present invention is not limited to this, and the form of the slit 72d can be arbitrarily changed. For example, the slit 72d may be a slit recessed in the +Z direction from the other end of the auxiliary portion 72D located in the −Z direction of the Z-axis direction. In addition, in the example illustrated in FIG. 22, the description has been given of the auxiliary portion 72D in which the two slits 72d are formed, but the number of slits may be one or three or more.

Further, the auxiliary portion 72D according to the present embodiment is in non-contact with the target object 6D in a standing posture. On the other hand, when the moving mechanism 3 is driven to displace the target object 6D to the lying posture after the target object 6D is gripped, the target object body portion 61 of the target object 6D comes into contact with the first portion 72a, and the third protrusion portion 64 of the target object 6D is inserted into the slit 72d. In addition, in the contact state where the target object body portion 61 of the target object 6D is in contact with the first portion 72a of the auxiliary portion 72D, the target object 6D is prevented from moving in the Z-axis direction by a static frictional force generated at a contact point between the first portion 72a and the target object body portion 61.

In the robot hand 7D according to the present embodiment, the hand unit 7aD is provided in the robot 1 so as to be capable of gripping the target object 6D in the standing posture and capable of changing the posture of the target object 6D from the standing posture to the lying posture. Then, by changing the posture of the target object 6D, the target object 6D rotates by the action of gravity and the target object body portion 61 comes into contact with the auxiliary portion 72D, so that the rotation of the target object 6D can be restricted.

In the robot hand 7D according to the present embodiment, the auxiliary portion 72D has the slit 72d into which the third protrusion portion 64 of the target object 6D can be inserted. Thus, the hand unit 7aD can grip the target object 6D having the third protrusion portion 64 protruding from the target object body portion 61 in the direction opposite to the protrusion portion 62 in the second direction (V axis).

### Fifth Embodiment

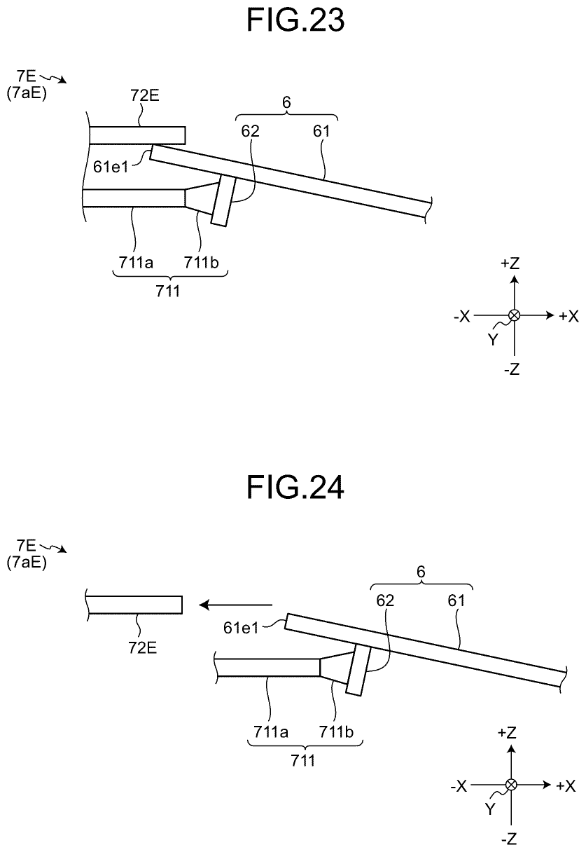

Next, a robot hand 7E according to a fifth embodiment will be described with reference to FIGS. 23 and 24. FIG. 23 is a view illustrating a state in which an auxiliary portion 72E of the robot hand 7E of the fifth embodiment at its contact position is in contact with the target object 6 in the lying posture. FIG. 24 is a view illustrating a state in which the auxiliary portion 72E is moved to a non-contact position with respect to the target object 6 in the lying posture. Note that, in the configuration of the robot hand 7E according to the fifth embodiment, the same components as those of the robot hand 7 according to the first embodiment are denoted by the same reference numerals and will not be described, and different components will be described below.

The target object 6 gripped by the robot hand 7E according to the present embodiment is, for example, as illustrated in FIG. 2.

The robot hand 7E according to the present embodiment includes a hand unit 7aE. The hand unit 7aE according to the present embodiment is formed separately from the body portion 711 and the auxiliary portion 72E, and the auxiliary portion 72E is provided movably with respect to the body portion 711. More specifically, the auxiliary portion 72E is provided in the coupling portion 712 so as to be movable from the contact position in contact with the target object 6 in the lying posture illustrated in FIG. 23 to the non-contact position in non-contact with the target object 6 illustrated in FIG. 24.

The auxiliary portion 72E according to the present embodiment is arranged at the non-contact position in the initial state, for example. Then, the moving mechanism 3 is driven to grip the target object 6 with the suction pad 711b. Thereafter, before the moving mechanism 3 is driven to displace the target object 6 to the lying posture, the auxiliary portion 72E is moved to the contact position, so that the target object body portion 61 of the target object 6 comes into contact with the auxiliary portion 72E when the target object 6 is displaced to the lying posture. In addition, in the contact state where the target object body portion 61 of the target object 6 is in contact with the auxiliary portion 72E, the target object 6 is prevented from moving in the X-axis direction by a static frictional force generated at a contact point between the auxiliary portion 72E and the target object body portion 61. After the target object 6 is moved to a predetermined position, the control unit 5 moves the auxiliary portion 72E to a non-contact position with respect to the body portion 711, and releases the contact state between the auxiliary portion 72E and the target object body portion 61. Thereafter, the control unit 5 drives the positive pressure source to increase the air pressure inside the suction pad 711b, thereby releasing the target object 6 gripped by the body portion 711.

In the robot hand 7E according to the present embodiment, the hand unit 7aE is provided in the robot 1 so as to be capable of gripping the target object 6 in the standing posture and capable of changing the posture of the target object 6 from the standing posture to the lying posture. Then, by changing the posture of the target object 6, the target object 6 rotates by the action of gravity and the target object body portion 61 comes into contact with the auxiliary portion 72E, so that the rotation of the target object 6 can be restricted.

In the robot hand 7E according to the present embodiment, the auxiliary portion 72E is provided movably with respect to the body portion 711 in the coupling portion 712. Thus, if the auxiliary portion 72E is moved with respect to the body portion 711 before the suction pad comes into contact with the target object 6, an area corresponding to the auxiliary portion 72E can be reduced when the robot hand 7E moves downward to grip the target object 6 in its upright state (standing posture); therefore, even in a state where multiple target objects 6 are arranged adjacent to each other at a smaller interval, the robot hand can grip the target object 6 without the body portion 711 coming into contact with another adjacent target object 6.

In the robot hand 7E according to the present embodiment, when the suction pad 711b grips the target object 6 in a standing posture, the auxiliary portion 72E is capable of retreating to a non-contact position where the auxiliary portion is in non-contact with the target object 6, and when the target object 6 reaches a predetermined position where the target object 6 is temporarily stored (palletized) and is stored at the predetermined position, the auxiliary portion is capable of retreating to the non-contact position where the auxiliary portion is in non-contact with the target object 6. Thus, at the time of releasing the gripped target object 6, it is possible to suppress variation in the position of the released target object 6.

Note that, the robot hand 7E according to the present embodiment may grip the target object 6A illustrated in FIG. 16 or may grip the target object 6B illustrated in FIG. 17.

Although the embodiments of the robot hands 7, 7A, 7B, 7C, 7D, and 7E according to the present invention have been described above, it is needless to say that the present invention is not limited to the embodiments, and various modifications can be made without departing from the gist of the present invention. In addition, the present invention also includes a configuration in which the components of the above embodiments and the configurations of the modified examples are appropriately combined. Various modifications made without departing from the gist of the present invention are also included in the technical scope of the present invention, and it is apparent to those skilled in the art from the description of the claims.

In the robot hand according to the present disclosure, in a state where the suction pad grips the target object, the distance in the second direction between the axis of the suction pad and the auxiliary portion is larger than the distance in the second direction from the axis of the suction pad to the surface of the first member on the side opposite to the surface of the first member brought into contact with the second member. Therefore, while the auxiliary portion is in non-contact with the target object when the robot hand grips the target object, the auxiliary portion comes into contact with the target object when the posture of the target object is changed, and thus the gripping force necessary for gripping the target object can be reinforced. This can make the work of changing the posture of the target object by a worker no longer necessary, and facilitate manufacturing of the structure by assembling the target object to another component.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A robot hand comprising:
a hand unit configured to grip a target object including a first member extending in a first direction and a second member extending in a second direction intersecting the first direction; and
a control unit configured to control the hand unit, wherein
the hand unit includes:
a body portion including a suction pad configured to suck the second member to grip the target object and a support portion configured to support the suction pad; and
an auxiliary portion provided to be opposed to the body portion in a state where the suction pad grips the target object, and
in a state where the suction pad grips the target object, a distance in the second direction between an axis of the suction pad and the auxiliary portion is larger than a distance in the second direction from the axis of the suction pad to a surface of the first member on a side opposite to a surface of the first member brought into contact with the second member.

2. The robot hand according to claim 1, wherein
the hand unit is provided to be capable of gripping the target object in a standing posture and changing a posture of the target object from the standing posture to a lying posture, and
the auxiliary portion is in non-contact with the target object in the standing posture but is capable of being in contact with the target object in the lying posture.

3. The robot hand according to claim 1, wherein
when gripping the target object in the standing posture, the axis of the suction pad and a suction surface of the second member are substantially orthogonal to each other, and
when gripping the target object in the lying posture, an angle formed by the axis of the suction pad and the first direction in which the first member extends is 10 degrees or less.

4. The robot hand according to claim 2, wherein
when gripping the target object in the standing posture, the axis of the suction pad and a suction surface of the second member are substantially orthogonal to each other, and
when gripping the target object in the lying posture, an angle formed by the axis of the suction pad and the first direction in which the first member extends is 10 degrees or less.

5. The robot hand according to claim 1, wherein
the auxiliary portion includes a base and a movement restriction portion, the movement restriction portion being formed of a material having a static friction coefficient larger than a static friction coefficient of a material forming the base, and
the auxiliary portion is in non-contact with the target object in the standing posture, and the movement restriction portion is capable of being in contact with the target object in the lying posture.

6. The robot hand according to claim 2, wherein
the auxiliary portion includes a base and a movement restriction portion, the movement restriction portion being formed of a material having a static friction coefficient larger than a static friction coefficient of a material forming the base, and
the auxiliary portion is in non-contact with the target object in the standing posture, and the movement restriction portion is capable of being in contact with the target object in the lying posture.

7. The robot hand according to claim 1, wherein
the target object includes a third member arranged at a position different from the second member,
the auxiliary portion includes a base and a recess portion, the recess portion being formed at the base, and
the auxiliary portion is in non-contact with the target object in the standing posture, and the third member of the target object in the lying posture comes into contact with an inner surface of the recess portion.

8. The robot hand according to claim 2, wherein
the target object includes a third member arranged at a position different from the second member,
the auxiliary portion includes a base and a recess portion, the recess portion being formed at the base, and
the auxiliary portion is in non-contact with the target object in the standing posture, and the third member of the target object in the lying posture comes into contact with an inner surface of the recess portion.

9. The robot hand according to claim 1, wherein
the target object includes a fourth member arranged at a position different from the second member,
the auxiliary portion includes a base and a slit, the slit being formed at the base, and
the auxiliary portion is in non-contact with the target object in the standing posture, and the base comes into contact with the target object in the lying posture and the fourth member of the target object is inserted into the slit.

10. The robot hand according to claim 2, wherein
the target object includes a fourth member arranged at a position different from the second member,
the auxiliary portion includes a base and a slit, the slit being formed at the base, and
the auxiliary portion is in non-contact with the target object in the standing posture, and the base comes into contact with the target object in the lying posture and the fourth member of the target object is inserted into the slit.

11. The robot hand according to claim 1, wherein
the auxiliary portion is provided movably with respect to the body portion.

12. The robot hand according to claim 2, wherein
the auxiliary portion is provided movably with respect to the body portion.

13. The robot hand according to claim 11, wherein
when the suction pad grips the target object in the standing posture, the auxiliary portion is capable of retreating to a non-contact position where the auxiliary portion is in non-contact with the target object, and
when the target object reaches a predetermined position where the target object is temporarily stored (palletized) and is stored at the predetermined position, the auxiliary portion is capable of retreating to the non-contact position where the auxiliary portion is in non-contact with the target object.

14. The robot hand according to claim 12, wherein
when the suction pad grips the target object in the standing posture, the auxiliary portion is capable of retreating to a non-contact position where the auxiliary portion is in non-contact with the target object, and
when the target object reaches a predetermined position where the target object is temporarily stored (palletized) and is stored at the predetermined position, the auxiliary portion is capable of retreating to the non-contact position where the auxiliary portion is in non-contact with the target object.

15. A robot hand comprising:
a hand unit configured to grip a target object; and
a control unit configured to control the hand unit, wherein
the hand unit includes:
a body portion including a suction pad configured to suck a surface of the target object to grip the target object and a support portion configured to support the suction pad; and
an auxiliary portion provided to be opposed to the body portion in a state where the suction pad grips the target object, and
in a state where the suction pad grips the target object, a distance in a second direction between an axis of the suction pad and the auxiliary portion is larger than a distance, in a direction in which the body portion and the auxiliary portion are opposed to each other, from the axis of the suction pad to an end of the surface in the surface of the target object.
